(19) United States
(12) Patent Application Publication
(10) Pub. No.: US 2004/0198326 A1
(43) Pub. Date: Oct. 7, 2004

(54) Personalized language announcements

(76) Inventor: Vijay Hirani, Middlesex (GB)

Correspondence Address: NIXON & VANDERHYE P.C., 8th Floor, 1100 North Glebe Road, Arlington, VA, 22201, US

(21) Appl. No.: 10/118,334

(22) Filed: Apr. 9, 2002

(51) Int. Cl. H04M 3/42

(52) U.S. Cl. 455/414.1

(57) ABSTRACT

A subscriber is permitted to select the language in which spoken messages from a network are communicated to that subscriber via the subscriber's user equipment. The subscriber identifies a language indicator to specify one of a plurality of different spoken languages. The subscriber's user equipment sends a message to the network including the language indicator to request that spoken language communications generated by the network for that subscriber's user equipment be in the spoken language corresponding to the language indicator. In response, the network may store the language indicator in a subscriber database for that subscriber's user equipment. When the network has a spoken language communication for the user equipment, it is generated in the spoken language corresponding the language indicator. The message can be sent to the network in any feasible manner, and example messages include a call setup message or a location registration/update message if the user equipment is a mobile radio type of user equipment.

### FIELD OF THE INVENTION

The present application relates to communications, and more particularly, to communication systems which are capable of generating and communicating spoken language messages with a subscriber's user equipment.

### BACKGROUND AND SUMMARY OF THE INVENTION

Current cellular communications standards do not allow a mobile subscriber to choose the language in which the subscriber wants to hear network-generated announcements. In the past, this was not a problem because most cellular network subscribers used a common language. However, with the increasing mobility of subscribers, there is a need for networks to be able to communicate with user equipments using different languages.

As described in the cellular GSM 02.40 standard, for example, advanced mobile stations can receive information from a cellular network in the form of a voice announcement in a specific language. In other words, upon receiving the information, (e.g., failure cause codes, an alert indication, etc.), in a signaling message from the mobile network, the mobile station's user interface translates the information to a voice message in a spoken language. The information could also be translated into other user friendly interfaces like text. The problem is that these spoken language communications in GSM 02.40 and elsewhere are only in one language. Therefore, multi-ethnic populations or market areas that encompass multiple countries with different languages are not satisfactorily serviced. Because of this inflexibility with respect to different spoken languages, the GSM 02.40 standard encourages the use of tones and discourages the use of spoken language messages to the detriment and inconvenience of subscribers.

The present invention overcomes this drawback and provides a method for permitting a subscriber to select the language in which spoken messages from a network are communicated to that subscriber via the subscriber's user equipment (UE). First, the subscriber identifies a language indicator to specify one of a plurality of different spoken languages. Second, the subscriber's user equipment sends a message to the network including the language indicator to request that spoken language communications generated by the network for that subscriber's user equipment be in the spoken language corresponding to the language indicator. In response, the network may store the language indicator in a subscriber database for that subscriber's UE. When the network has a spoken language communication for the user equipment, it is generated in the spoken language corresponding to the language indicator. The message can be sent to the network in any feasible manner. Non-limiting example messages include a call setup message or a location registration/update message if the user equipment is a mobile radio-type of user equipment.

### BRIEF DESCRIPTION OF THE DRAWINGS

The foregoing and other objects, features, and advantages of the present invention may be more readily understood with reference to the following description taken in conjunction with the accompanying drawings.

FIG. 1 is a function block diagram of a communications system in which the present invention may be employed;

FIG. 2 is a flowchart which outlines example procedures in accordance with one embodiment of the invention;

FIG. 3 illustrates in function block form a mobile communications system in which the present invention may be employed; and

FIGS. 4-6 illustrate signaling diagrams associated with the mobile communications system shown in FIG. 3 where example messages are illustrated for carrying a language indicator.

### DETAILED DESCRIPTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details. For example, while the present invention is described later in an example application to a GSM type of cellular communication system, the present invention may be employed in any communication system (wired or wireless) that offers network-generated, spoken language services.

In some instances, detailed descriptions of well-known methods, interfaces, devices, and signaling techniques are omitted so as not to obscure the description of the present invention with unnecessary detail. Moreover, individual function blocks are shown in some of the figures. Those skilled in the art will appreciate that the functions may be implemented using individual hardware circuits, using software functioning in conjunction with a suitably programmed digital microprocessor or general purpose computer, using an application specific integrated circuit (ASIC), and/or using one or more digital signal processors (DSPs).

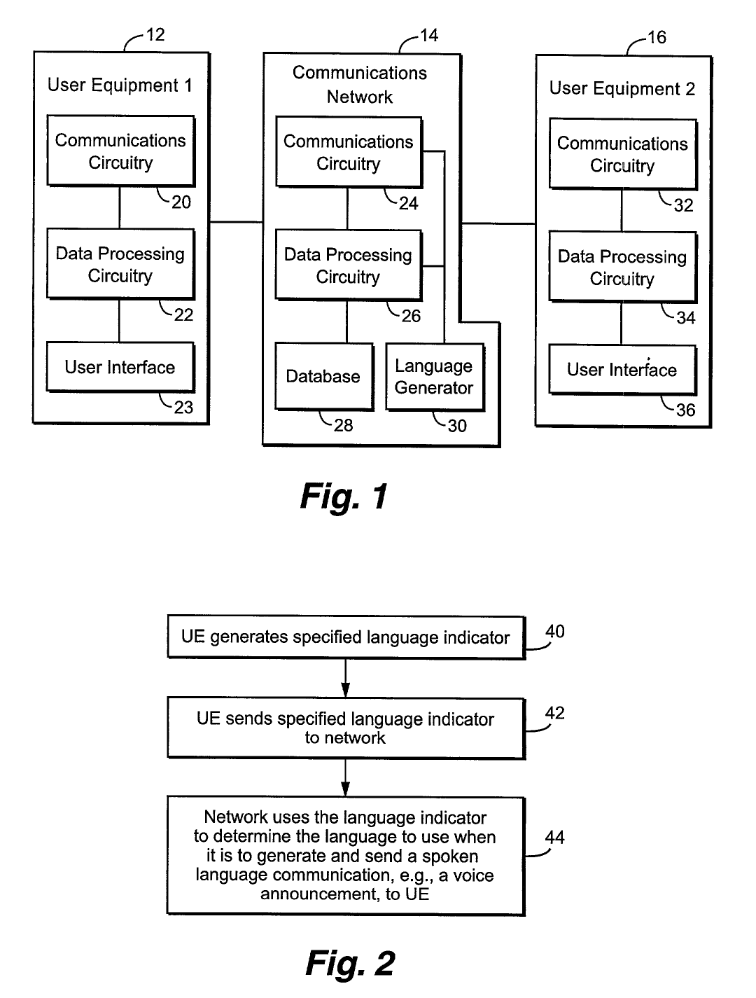

FIG. 1 illustrates a communications system 10 in which the present invention may be employed. The system 10 can be wired or wireless. A first user equipment 1 (UE 1) identified by reference number 12 communicates with a communications network 14 and, if desired, with other user equipments such as user equipment 2 (UE2) shown as reference numeral 16 byway of the communications network 14. UE1 includes communications circuitry 20 for effecting communication over a communications interface with the communications network 14. Data processing circuitry 22 is used to control or otherwise implement various operations performed by the user equipment 12 including controlling the communications circuitry 20, a user interface 23, and generating and sending one or more messages which include a language indicator as described in more detail below. The user interface 23 preferably includes circuitry and a speaker (not shown) for playing spoken language messages and an optional display for displaying the text corresponding to those spoken language messages.

The communications network 14 includes communications circuitry 24 for communicating with various user equipments. The data processing circuitry 26 is coupled to the communications circuitry 24 and to a database 28 which can be used, for example, to store user equipment subscriber information. The data processing circuitry 26 and the communications circuitry 24 are also coupled to a language generator 30 which generates data, that when received and reproduced by a UE user interface, corresponds to one of a plurality of spoken languages. The second user equipment 16 includes communications e circuitry 32, data processing circuitry 34, and user interface 36 which are similar to those described for user equipment 12.

Reference is now made to the procedures shown in the flowchart of FIG. 2 in accordance with one example embodiment of the invention. When a subscriber desires to select a particular language that the subscriber desires to receive in a UE spoken language (or text) messages from the communications network 14, e.g., announcements, authentication requests (PIN code requests), bank interaction menus (balance, credit limits, etc.), network operator information, network information (subscriber busy, network congestion, etc.), advertisements, games, or other entertainment, etc., the UE generates a specified language indicator based upon the language specified by the UE subscriber (step 40). The user equipment could be a wired user equipment, a fixed wireless user equipment, or a mobile wireless user equipment. The UE sends the specified language indicator to the communications network in some form, and in the preferred example embodiment, that language indicator is sent as an information element in some type of message. Preferably, an existing message would otherwise be sent from the user equipment to the communications network 14 is used. Alternatively, the subscriber may provide this information to the communications network in some other fashion. In any event, that specified language indicator is stored in the database 20 of the communications network 14. The network 14 then analyzes the language indicator to determine which of plural languages to use when network-generated spoken language communication are to be sent to the user equipment (block 44).

In one example, the language indicator message is sent as part of a call setup operation message. In the context of a mobile communications network, the language indicator could also be sent in a location registration or location update message. While the language indicator may be formatted as a text string, it is preferably formatted as an octet string. Moreover, in the context of a user equipment 12 calling another user equipment 16, the communications network may also receive a language indicator from the user equipment 16 which need not be the same as the language indicator associated with user equipment 12. The communications network stores both language indicators for both user equipments and communicates with each of the user equipments using the language associated with that user equipment's corresponding language indicator.

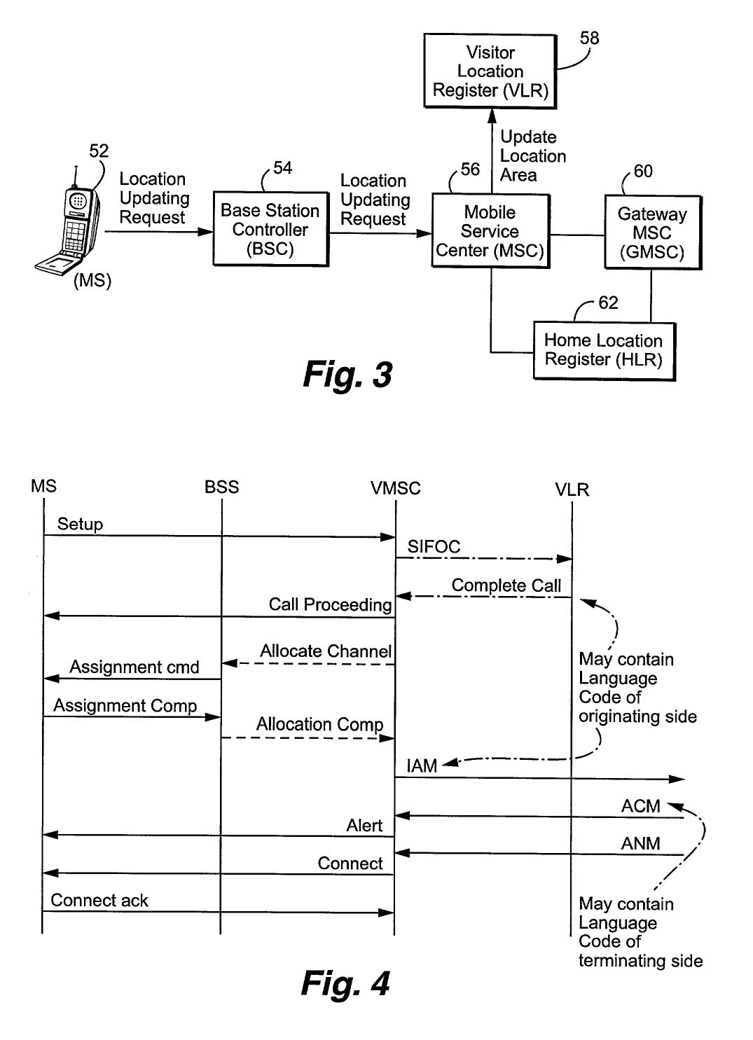

Another non-limiting, example embodiment of the present invention is now described in the context of a GSM-based cellular communications system presented in simplified function block format in FIG. 3 at reference numeral 50. Here the user equipment is a wireless mobile station (MS) 52. Since GSM cellular communications are well-known by those skilled in the art, reference is made to standard GSM nodes and messages without detailed explanation. Detailed information about GSM nodes, and GSM messages in particular, may be readily acquired from various publicly-available GSM standards.

The mobile station 52 is shown in this example to communicate its specified language indicator in a Location Updating Request sent to Base Station Controller (BSC) 54 which forwards it to the Mobile Switching Center (MSC) 56. This message is sometimes called an IMSI Attach message, where IMSI refers to International Mobile Subscriber Identification. The format of the Location Update Request message is described in more detail in the GSM 04.08 standard. A new information element (IE), called “language code” and corresponding to a language indicator, may be added to this message. The format is preferably an octet string of sixteen bits (two octets) which allows over 65,000 spoken languages to be uniquely identified. The MSC 56 sends this language code to the Visitor Location Register (VLR) 58 in a Mobile Application Part (MAP) message “Update Location Area” described in detail in the GSM 09.02 standard. A new parameter called “language code” is also preferably added in the “Update Location Area” MAP message and will have the same structure as in the “Location Updating Request” message. The VLR 58 stores the language code in the subscriber's database record along with other subscriber and location related information.

An example for the Location Updating Request message is shown below in

TABLE 1
Location Updating Request Message (partial)

| Mobility management | M | V | ½ |
|---|---|---|---|
| protocol discriminator | | | |
| ““ | ““ | ““ | ““ |
| Mobile identity | M | LV | 2-9 |
| Language code (new) | O | F | 2 |

An example format for the Update Location Area message corresponding to a parameter list is provided in Table 2.

TABLE 2
Update Location Area Message (partial)

| Parameter Name | Req | Ind | Resp | Conf |
|---|---|---|---|---|
| Invoke id | M | M(=) | M(=) | M(=) |
| ““ | ““ | ““ | ““ | ““ |
| Provider error | | | | O |
| Language code (new) | O | O(=) | | 2 |

The standard ISO 639 “codes of representation of names of languages” includes a comprehensive list of language codes. These language codes are represented as three alphanumeric letters which could be used instead of octet strings. However, text strings such as IA5 strings are difficult to work with in telephony networks, especially if analysis of data is required. Therefore, it is preferred that the ISO 639 language codes be mapped to a unique octet string value which is easier to analyze in the network.

An example of a mobile originating call in which an example of the present invention is employed will now be described in conjunction with the signaling diagram shown in FIG. 4. At some point in time during call setup, the visiting MSC 56 will receives setup message from the mobile station. The call setup sequence shown in FIG. 4 takes place after authentication and security checks have been performed. The setup message triggers the sending of a Send Information For Outgoing Call (SIFOC) MAP message to the VLR 58. The VLR returns the “complete” call message as a reply. The complete call MAP message preferably includes the language code for the mobile station subscriber. GSM 09.02 provides further information on the structure of the complete call MAP message.

The language code will be employed whenever an announcement or other message needs to be played (or displayed if text). The announcements are played by announcement devices or intelligent peripherals developed by various market vendors. All announcement phrases are programmed (in some cases etched on EPROM boards) in the announcements devices. The network will order the announcement devices to play the selected announcement. The communications protocol between the network and the announcement devices can be proprietary or can be a standardized protocol like Gateway Control Protocol. Some announcement devices are embedded in the network itself, in which case a communication protocol is not necessary.

In order to pass the language code across the network to the Gateway MSC (GMSC) of the called subscriber (not shown in FIG. 3), specific updates may be made to the network protocol. For example, if the ISDN User Part (ISUP) is used, then the language code may be carried in the repeatable (generic digits) field in the Initial Address Message (IAM). Alternatively, the Access Transport Parameter (ATP) may be used. Similarly, for other protocols like Session Initiation Protocol (SIP) or Bearer Independent Call Control (BICC) used in third generation UMTS networks, the protocol may be adapted to carry the language code. Of course, other protocols may be adapted to do the same. In the response from the terminating side, i.e., an Address Complete Message (ACM), a language code from the called subscriber may be included which indicates the preferred spoken language of the terminating subscriber. Therefore, the originating VMSC 56 will have two language codes which will be implemented depending on where the spoken language announcement is to be played.

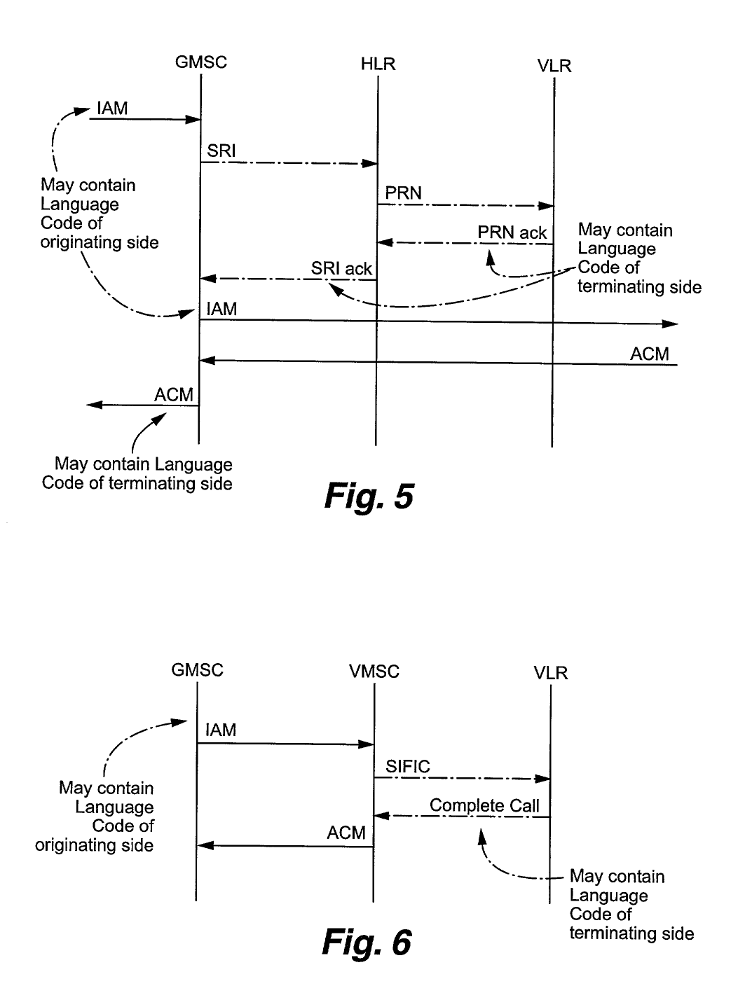

An example implementation of the invention for a mobile terminating call is now described in the context of the signaling diagram shown in FIG. 5. The incoming call to a mobile station terminates in a GMSC, the language code of the terminating subscriber may be retrieved from the VMSC using the MAP messages Provide Roaming Number (PRN) ACKnowledge and Send Routing Information (SRI) ACKnowledge. GSM 09.02 provides more detailed information regarding these two MAP messages. In any event, the GMSC stores the language code in the Home Location Register (HLR) 62 for the subscriber as well as the current VLR 58. The GMSC may also receive the language code of the originating side in the call setup message, i.e., the Initial Address Message (IAM). Again, it is possible that the two language codes for the originating and terminating sides are different. After setup of the call to the terminating part by way of the VMSC, an ACKnowledge Message (ACM) may be sent back to the originating side which includes the language code of the terminating side. For example, the Access Transport Parameter (ATP) in the ACKnowledge Message (ACM) may be used to do this. For other protocols, network operator-specific parameters may be used to transfer the terminating side language code to the originating side.

A scenario in which the present invention is employed for a mobile terminating call is described in conjunction with the signaling diagram in FIG. 6. Here, the VMSC on the terminating side receives a call setup message (e.g., IAM) from the GMSC. The setup message includes the language code from the originating side. Again, the language code may be in “generic digits” or as an ATP parameter in the IAM. The VMSC will send a send information for incoming call (SIFIC) to the VLR to obtain to called party information. The reply MAP message “Complete Call” will be updated as described above to carry the terminating subscriber's language code. The language code of both or either the called and calling subscribers will then be referenced when announcements are to be played to either of them.

The present invention can be implemented in any network. For example, 5 transit exchanges may use language codes required to play specific announcements. For Intelligent Network (IN) or Customized Applications for Mobile network Enhanced Logic (CAMEL) calls, the language codes can be sent to the Supervisory Control Function (SCF) as extensions. See GSM 09.78. The SCF may use this information to play appropriate announcements.

Of course, there are many other variations of how the solution provided by the present invention could be implemented so that the network is informed of the spoken language which is preferred by the UE. Indeed, the present invention is especially useful in countries with multi-ethnic populations. It is also useful for countries in integrated trade markets where many countries with different languages are involved, e.g., the European Union (EU).

While the present invention has been described with respect to particular embodiments, those skilled in the art will recognize that the present invention is not limited to these specific exemplary embodiments. Different formats, embodiments, and adaptations besides those shown and described as well as many variations, modifications, and equivalent arrangements may also be used to implement the invention. Therefore, while the present invention has been described in relation to its preferred embodiments, it is to be understood that this disclosure is only illustrative and exemplary of the present invention. Accordingly, it is intended that the invention be limited only by the scope of the claims appended hereto.

What is claimed is:

1. A method for use in a communications system, comprising:
specifying a first language indicator corresponding to one of a plurality of different spoken languages, and
sending a first message from a first user equipment to an network including the first language indicator to request that a spoken language communication generated by the access network for the user equipment be in the spoken language corresponding to the first language indicator.

2. The method in claim 1, wherein in response to the first message, storing the first language indicator in a database.

3. The method in claim 1, wherein the first message is sent as part of a call setup operation.

4. The method in claim 1, wherein in response to the first message, the access network generates a spoken language communication corresponding to the first language indicator.

5. The method in claim 4, wherein the spoken language communication is an announcement.

6. The method in claim 4, further comprising:
receiving the first message during set up of a connection between the first user equipment and a second user equipment;
receiving a second message from the second user equipment including a second language indicator corresponding to another of the plurality of spoken languages to request that a spoken language communication generated by the access network for the second user equipment be in the spoken language corresponding to the second language indicator.

7. The method in claim 6, wherein in response to the first and second messages, the access network generates a spoken language communication corresponding to the first language indicator when communicating with the first user equipment and a spoken language communication corresponding to the second language indicator when communicating with the second user equipment.

8. The method in claim 1, wherein the first user equipment is a mobile radio and the access network includes a radio access network, and wherein the first message is sent as part of a location registration or update operation.

9. The method in claim 1, wherein the first user equipment is a wireless or a wired user equipment.

10. The method in claim 1, wherein the first language indicator is a text string or an octet string.

11. Auger equipment comprising:
communication circuitry for communicating with an access network;
processing and storage circuitry configured with a language indicator corresponding to one of a plurality of spoken languages and configured to send a message to the access network including the language indicator to request that a spoken language communication generated by the access network for the user equipment be in conducted in the spoken language corresponding to the language indicator.

12. The user equipment in claim 11, wherein the first message is sent as part of a call setup operation.

13. The user equipment in claim 11, wherein the user equipment is a mobile radio and the access network includes a radio access network, and wherein the message is sent as part of a location registration or update operation.

14. The user equipment in claim 11, wherein the user equipment is a wireless or a wired user equipment.

15. Communication network apparatus comprising:
communication circuitry for communicating with plural communication network subscribers, and
data processing circuitry configured to receive a first message from a first subscriber including a first language indicator corresponding to one of a plurality of spoken languages, interpret the first language indicator as a request that a spoken language communication generated by the network for the subscriber be in the spoken language corresponding to the first language indicator, and generating a spoken language communication for the subscriber in the spoken language corresponding to the first language indicator.

16. The communication network apparatus in claim 16, further comprising:
a memory for storing information about communication network subscribers including the first language indicator for the first subscriber.

17. The communication network apparatus in claim 16, wherein the first message is sent as part of a call connection setup operation.

18. The communication network apparatus in claim 16, wherein the spoken language communication is an announcement.

19. The communication network apparatus in claim 16, wherein the first message is received during set up of a connection between the first user equipment and a second user equipment, and
wherein the data processing circuitry is further configured to receive a second message from the second user equipment including a second language indicator corresponding to another of the plurality of spoken languages to request that a spoken language communication generated by the network for the second user equipment be in the spoken language corresponding to the second language indicator.

20. The communication network apparatus in claim 19, wherein in response to the first and second messages, the data processing circuitry is further configured to generate a spoken language communication corresponding to the first language indicator when communicating with the first user equipment and a spoken language communication corresponding to the second language indicator when communicating with the second user equipment.

21. The communication network apparatus in claim 16, wherein the user equipment is a mobile radio and the message is sent as part of a location registration or update operation.

22. The communication network apparatus in claim 16, wherein the user equipment is a wireless or a wired user equipment.

23. The communication network apparatus in claim 16, wherein the first language indicator is a text string or an octet string.
